(19) United States
(12) Patent Application Publication
(10) Pub. No.: US 2008/0044888 A1
(43) Pub. Date: Feb. 21, 2008

(54) Biofilter System and Method for Purifying Gases Escaping From a Gully Hole

(76) Inventors: Peter Harborth, Braunschweig (DE); Helmut Hanert, Braunschweig (DE); Matthias Nieber, Gommern (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 10/551,332

(22) PCT Filed: Mar. 5, 2004
(86) PCT No.: PCT/DE04/00430

§ 371 Date: Jan. 21, 2007

(30) Foreign Application Priority Data
Mar. 31, 2003 (DE) 103 14 748.9

(51) Int. Cl. B01D 53/38; B01D 35/02

(52) U.S. Cl. 435/266; 55/318

(57) ABSTRACT

The invention relates to a method for purifying gases escaping from a gully hole (1), particularly escaping from a sewer (8) guided at the bottom (7) of the gully hole (1) by means of a biofilter that is arranged inside the gully hole (1) in such a manner that the gases flow through it before they leave the gully hole (1). The biofilter is mounted at such a distance to the sewer (8) that its temperature and moisture are substantially influenced by the waste water (17) present in the sewer (8).

The invention relates to a method for purifying gases escaping from a gully hole, which gases exit from a sewer conducted in the bottom of the gully hole, by means of a biofilter which is arranged in the gully hole in such a manner that the gases pass through it before they leave the gully hole.

The invention further relates to a wastewater-biofilter arrangement for installing a biofilter in a gully hole which extends by a vertical wall over an essentially horizontal sewer which is arranged in a bottom of the gully hole to an exit hole which can be closed by a manhole having a sealing arrangement having a through-hole and a mounting device for mounting the biofilter extending over the through-hole. The invention further relates to a gully hole provided with such a wastewater-biofilter arrangement.

It is known that, in particular in the case of a design as a closed pressure line of sewers laid underground, considerable odor problems can be caused at the gully holes at which the pressure line is designed to be open. The most well known odor nuisance is due to hydrogen sulfide which forms readily in the anaerobic environment of the pressure sewers and, on transition to the atmospheric pressure in the gully hole, leaves the wastewater to an increased extent. The anaerobic environment necessary for the formation of hydrogen sulfide forms in the pressure sewers in particular when the wastewater stands still in the lines for a certain time, that is to say in times of low wastewater production.

It is known to attempt a solution of the odor problem by adding to the wastewater suitable chemicals, for example nitrate as oxygen carrier (to avoid the anaerobic environment) and lime (to avoid the pH depression) (Schubert, Günthert “Geruchsprobleme in Abwasserdruckleitungen” [Odor problems in pressure sewers], EP 1-2/99, 44-49). However, the addition of chemicals is not without problems, since the metering would always have to be performed as a function of wastewater production. Furthermore, the costs of the chemicals required in considerable amounts arising for a wastewater disposal system are high, so that there is a requirement for cheaper solutions.

It is known to connect a biofilter into gullies to the gully cover closing the gully, or to the collection basket for leaves or the like situated immediately beneath this. To ensure that the gases ascending from the gully pass through the biofilter, this is sealed radially outward from the wall in the cylindrical part of the gully wall tapered for the gully opening, for example by a clamping apparatus which presses an elastic material radially outward against the wall of the gully in the upper tapered part (pamphlet of the company RETEC “Biofilter PFEZI® air clean”). Alternatively to this, it is known to make the seal to the gully wall in the upper constricted region by means of peripheral radially projecting elastic lips which, on insertion into the gully, because of the radial oversize, are bent upward by the wall of the gully, so that, owing to their elastic restitution forces, they fit tightly against the gully wall in the region tapered for the gully cover (Flyer “BIO FILTER ANLAGEN bio-desodor®-Systeme” [bio-desodor® biofilter systems] from Echtner+Nimsgarn).

The biofilters used consist of customary biofilter material, for example bark mulch, which is particularly suitable as a support of the microorganisms degrading the odor substances, in particular sulfides. Although the biofilters are suitable in principle for purifying exhaust gases, the biofilters used in gullies are regularly ineffective after a short time. This is because the bacteria decomposing the odor substances require defined environmental conditions for their activity. If the ambient temperature falls to below +5° C., for example, the activity of the microorganisms falls virtually completely. A similar problem exists when, owing to the absence of precipitation which, furthermore, only pass with limitations into the gullies, the biofilter dries out. It would therefore be necessary to provide the biofilters with moisture regularly in dry weather periods by spraying. However, such regular maintenance of the biofilter arrangements would fail due to practical problems and the associated expenditure.

The object therefore underlying the invention is to specify a solution for eliminating the odor nuisance which functions as inexpensively and reliably as possible, even without weather-dependent maintenance.

This object is achieved according to the invention using a method of the type mentioned at the outset by such a means that the biofilter is arranged at such a distance to the sewer that its temperature and moisture are significantly influenced by the wastewater present in the sewer.

The inventive method exploits the fact that the wastewater is regularly produced in closed buildings and is therefore only exposed to small weather-dependent influences, especially since it is transported underground at relatively great depths in which weather-related temperature variations have only small effects. Installing the biofilter as close as possible to the wastewater standing or flowing in the sewer thus has the effect that the biofilter is exposed by the wastewater itself only to significantly lower temperature variations and can be kept sufficiently moist continuously by the water vapor of the wastewater.

Contrary to the known solutions, the biofilter is thus not installed in the upper part of the gully, in which this is regularly tapered to a size corresponding to the standard size of a gully cover, but in the lower part of the gully in which the diameter is enlarged for access by maintenance personnel and does not have standardized cross-sectional areas.

Expediently, the biofilter is arranged in the lower half of the gully, preferably a sealed collection space having a through-hole to the biofilter being constructed beneath the biofilter. Particularly preferably, the gas collection space is designed to be as small as possible in order to make the temperature effect of the wastewater and the moistening of the biofilter by the wastewater as effective as possible.

To solve the object mentioned, in addition, a wastewater-biofilter arrangement of the type mentioned at the outset is characterized in that the sealing arrangement for sealing off at the gully is constructed in a lower part of the gully and the biofilter is constructed for arranging in the lower part of the gully. The “lower part” of the gully specifies here that part which is situated beneath the diameter of the gully which is tapered toward the gully cover. The maximum possible distance between the biofilter and the seal of the sewer crossing the gully results for those skilled in the art from the sought-after procedure of the method, that is to say from maintaining the vitality of the microorganisms present in the biofilter by the influence of the wastewater in the sewer.

Preferably, the sealing arrangement has a gas-permeable partition wall forming the through-hole, on which partition wall the biofilter is arranged. Accordingly, a preferred two-piece construction of the biofilter arrangement results from a lower part which is provided with the sealing arrangement and having a gas collection space and an upper part containing the biofilter, which can be mounted on the lower part in gas-stream-communicating connection.

It can be expedient here to produce the lower part in a size and a design matched to the respective conditions of the gully, while the upper part is constructed in standard size. Accordingly, the gas-permeable partition wall between lower part and upper part is likewise constructed in standard size.

In a preferred embodiment of the invention, the sealing arrangement has sealing elements for sealing on the bottom on both sides of the sewer. The sealing arrangement can expediently be constructed on a box open at the bottom which is provided with sealing elements suitable for lying on the bottom of the gully. For the end-side seal, sealing elements directed toward the wall of the gully can be provided. Alternatively to this, it is possible, for the end-side seal, to provide sealing elements which are suitable for close fitting to closed pipe attachments projecting into the gully. The seal is then made in a particularly simple manner on the outside of the pipe attachments of the sewer made in a standardized size.

A sealing arrangement which can be implemented independently of the bottom of the gully can have a sealing element which is provided for close fitting to the wall of the gully and the radial expansion of which is adjustable. The radial expansion can be adjusted by a clamping device for an elastic sealing element, which clamping device is known from the prior art, but can also be implemented by a flexible tubular sealing element being designed to be inflatable.

The inventive object is further achieved by a gully which is provided with the described wastewater-biofilter arrangement and, in particular, can be especially constructed for receiving the wastewater-biofilter arrangement, for example by building in a flange-like receiving device for the biofilter arrangement.

The sewer crossing the gully is, as mentioned, preferably connected to a pressure sewer, since the problem of odor nuisance occurs most severely in such a pressure sewer.

The invention is to be described in more detail hereinafter with reference to an exemplary embodiment shown in the drawing. In the drawing:

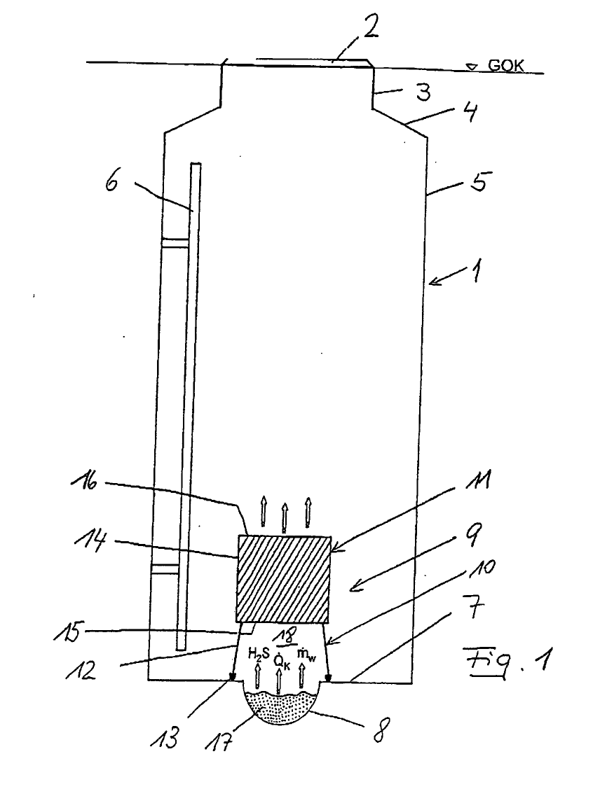

FIG. 1 shows a section through a gully having a wastewater-biofilter arrangement according to an exemplary embodiment of the invention

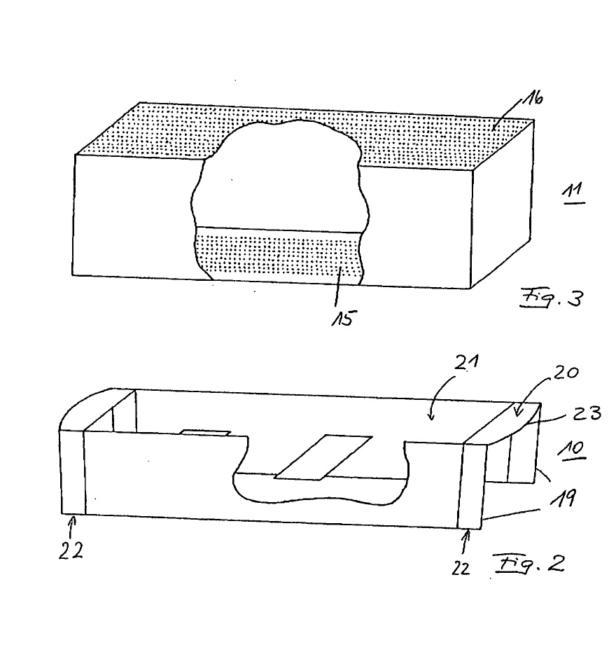

FIG. 2 shows a perspective view of a lower part of the biofilter arrangement according to FIG. 1

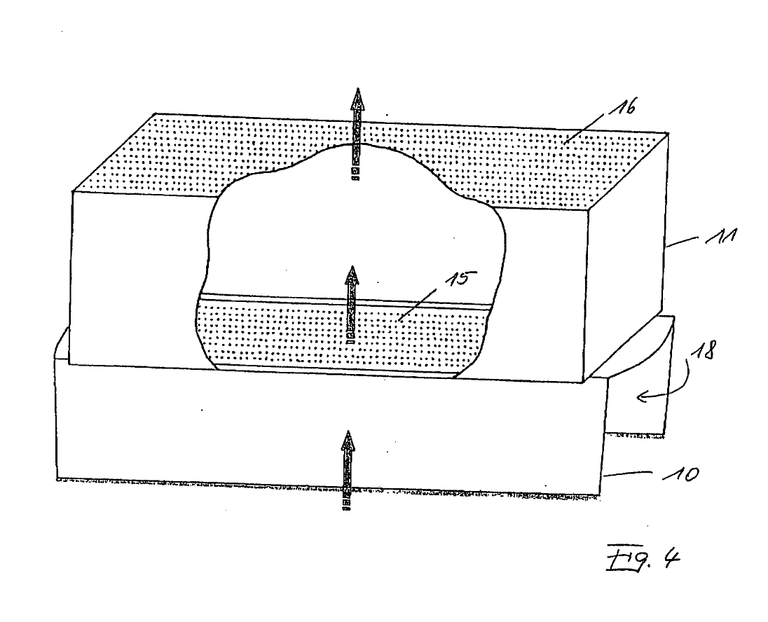

FIG. 3 shows a perspective view, partially broken-out view of an upper part of the biofilter arrangement according to FIG. 1

FIG. 4 shows a diagrammatic perspective, partially broken-out, view of the biofilter arrangement formed of lower part and upper part.

FIG. 1 shows a surface level GOK, at which a gully 1 is sealed by a conventional gully cover 2. Beneath the gully cover 2, the gully 1 has a cylindrical upper section 3 which transforms via an expansion 4 into a cylindrical wall 5 of a lower section of the gully 1. On the cylindrical wall 5 there is fixed a ladder 6 by which a person can climb down into the gully 1 for maintenance work. The gully 1 has a bottom 7 into which is set a channel-like sewer 8. The sewer 8 customarily consists of a semicircular pipe open at the top which crosses the gully 1 roughly horizontally. The sewer 8 designed as a passage sewer enters the cross section of the sewer 1 by closed pipe ports and then transforms into the sewer 8 open at the top, before it continues again with a closed pipe at the other end of the gully 1.

FIG. 1 shows that the sewer 8 which is open at the top has a biofilter-arrangement 9 built over it, which biofilter arrangement consists of a lower part 10 and an upper part 11. The lower part 10 is constructed as a box 12 which is open at the bottom, extends over the length of the sewer 8, and on its lower edge lying on the bottom 7 is provided with an elongate sealing element 13.

The upper part 11 forms a closed box 14 having a lower side 15 and an upper side 16 which are both constructed as gas-permeable walls, for example in the form of a plastic or textile mesh, the upper side 16 also being able to be constructed so as to be open.

Arrows in FIG. 1 indicate that gases leave the waste-water 17 transported in the sewer 8; as the most important odor-forming gas, H₂S is shown as a symbol. The water evaporating from the wastewater 17 produces a mass flow rate \dot{m}_{w}, by which water is transported into a gas collection space 18 formed by the box 12. The evaporating water also produces a heat transport \dot{Q}ₖ into the gas collection space 18. Via the gas-permeable bottom 15 of the upper part 11, not only the gas (H₂S), but also the heat and the vaporized water pass into the upper part 11 which is packed with biofilter material and forms the biofilter. After it has flowed through the biofilter, the gas which has left the wastewater 17 is microbiologically converted, so that it no longer causes odor nuisance. Incoming H₂S is oxidized to H₂SO₄.

To prevent premature acidification of the biofilter in the upper part 11, it is expedient to add lime to the biofilter material, which lime addition significantly retards the pH reduction on account of its buffering action.

FIG. 2 shows a perspective, partially broken-out view of the lower part 10 which is constructed as a box (open at the bottom) of U-shaped cross section, which has two vertical legs 19 and an upper side 20. The upper side 20 is formed by an opening 21 extending over the entire length up to the end pieces 22.

The end pieces 22 continue the shape of the lower part 10 and are constructed as a soft elastic sealing element which, on the upper side, has a rounded edge 23 matched to the curvature of the wall 5 of the gully 1.

The upper part 11 shown in FIG. 3 is a closed box, the upper side 16 and lower side 15 of which are formed by gas-permeable walls, here indicated by walls provided with through-holes. The upper part 11 is packed ready for use with biofilter material, for example in the form of bark mulch, which serves as support for the microorganisms converting the gas (H₂S). The biofilter material is, as shown in FIG. 1, not only heated but also moistened by the waste-water 17.

FIG. 4 again indicates the passage of the raw gas leaving the wastewater 17 into the gas collection space 18 of the lower part 10 through the gas-permeable bottom wall 15 of the upper part 11 into the biofilter material and out upward through the gas-permeable upper side 16 of the upper part 11. Owing to the convection flow, the purified exhaust air ascends further in the gully 1 and leaves the gully 1, generally into the open air, through the gully cover 2 which is provided with openings.

FIG. 4 shows that the upper part 11 forming the biofilter can have a standard size, since it does not contribute to sealing off the gas collection space 18 from the gully 1, whereas the lower part 10 must be constructed for sealing off the gas collection space 18 from the gully 1.

Alternatively to the end-side seal on the wall 5 by means of the sealing attachments 22, it is also possible to provide the lower part 10 with end walls which are adapted to the (half) diameter of closed pipe ports projecting into the gully 1 and are provided with corresponding soft elastic seals at the transition to the pipe port. In this manner, the lower part 10 can be sealed from the bottom 7 of the gully 1 and the pipe ports.

In a further alternative, the seal from the bottom 7 can be dispensed with, if a radial seal of the gas collection space at the cylindrical wall 5 in the lower region of the gully 1 is solely provided.

According to the invention the biofilter thus arranged remains active independently of the weather conditions outside the gully 1, since it is kept in a suitable temperature and moisture range by the action of the moisture and heat transferred from the wastewater 17, without external actions being necessary for this.

1. A method for purifying gases escaping from a gully hole (1), which gases exit from a sewer (8) conducted in the bottom (7) of the gully hole (1), by means of a biofilter which is arranged in the gully hole (1) in such a manner that the gases pass through it before they leave the gully hole (1), characterized in that the biofilter is arranged at such a distance to the sewer (8) that its temperature and moisture are significantly influenced by the wastewater (17) present in the sewer (8).

2. The method as claimed in claim 1, characterized in that the biofilter is arranged in the lower half of the gully hole (1).

3. The method as claimed in claim 1 characterized in that, beneath the biofilter, a sealed collection space (18) having a through-hole (15) to the biofilter is constructed.

4. A wastewater-biofilter arrangement for installing a biofilter in a gully hole (1) which extends by a vertical wall (5) over an essentially horizontal sewer (8) which is arranged in a bottom (7) of the gully hole (1) to an exit hole which can be closed by a manhole (2) having a sealing arrangement (13, 22) having a through-hole and a mounting device for mounting the biofilter extending over the through-hole for carrying out the method as claimed in claim 1, characterized in that the sealing arrangement (13, 22) for sealing off the gully hole (1) is constructed in a lower part of the gully hole (1) and the biofilter is constructed for arranging in the lower part of the gully hole (1).

5. The wastewater-biofilter arrangement as claimed in claim 4, characterized in that the sealing arrangement (13, 22) is closed by a gas-permeable partition wall (15) forming the through-hole, on which partition wall the biofilter is arranged.

6. A wastewater-biofilter arrangement as claimed in claim 4 characterized in that the sealing arrangement (13, 22) has sealing elements (13) for sealing on the bottom (7) on both sides of the sewer (8).

7. The wastewater-biofilter arrangement as claimed in claim 4, characterized in that, for the end-side seal, sealing elements (22) directed toward the wall (5) of the gully hole (1) are provided.

8. The wastewater-biofilter arrangement as claimed in claim 4, characterized in that, for the end-side seal, sealing elements suitable for close fitting to closed pipe attachments projecting into the gully hole (1) are provided.

9. The wastewater-biofilter arrangement as claimed in claim 4, characterized in that the sealing arrangement has a peripheral sealing element closely fitting to the wall of the gully hole (5), the radial expansion of which sealing element is adjustable.

10. The wastewater-biofilter arrangement as claimed in claim 4, characterized in that the sealing arrangement (13, 22) is situated on a lower part (10) having a gas collection space (18), and in that an upper part (11) containing the biofilter can be mounted on the lower part (10) in communicating connection via the gas-permeable partition wall (15).

11. The wastewater-biofilter arrangement as claimed in claim 10, characterized in that the upper part (11) is constructed in a standard size and can be mounted on lower pats (10) of different sizes.

12. A gully hole having a wastewater-biofilter arrangement (9) as claimed in claim 4.

13. The gully hole as claimed in claim 12, characterized in that the sewer (8) crossing the gully hole (1) is connected to a wastewater pressure line.

14. The gully hole as claimed in claim 12 characterized in that it is constructed having mounting elements for mounting the biofilter arrangement (9).
